(19) United States
(12) Patent Application Publication
(10) Pub. No.: US 2012/0261856 A1
(43) Pub. Date: Oct. 18, 2012

(54) METHOD FOR MANUFACTURING PRODUCTS MADE OF COMPOSITE MATERIAL WITH A CLOSED-SECTION SANDWICH STRUCTURE

(75) Inventor: Ruggero Pitzolu, Spinetoli (IT)

(73) Assignee: ALENIA AERMACCHI S.p.A, Venegono Superiore (IT)

(21) Appl. No.: 13/443,579

(22) Filed: Apr. 10, 2012

(30) Foreign Application Priority Data
Apr. 12, 2011 (IT) TO2011A00332

(51) Int. Cl. B29C 70/46; B29C 69/02

(52) U.S. Cl. 264/152; 264/258

(57) ABSTRACT

A matched mold curing apparatus defining a molding cavity has two sets of layers of curable, fiber-reinforced, thermosetting composite material laminated on a lower forming tool and upper forming tool. Closed-cell foam core segments are provided and placed adjacent to each other on the layers. The core segments are oversized with respect to the nominal size determined by the molding cavity in the closed condition, minus the thickness of the layers of composite material. A controlled temperature is applied firstly to allow plastic deformation of the core segments, but without closing completely the matched mold. The temperature and pressure are then applied to cause complete closure of the matched mold and curing of the laminated layers.

This application claims benefit of Serial No. TO2011A000332, filed 12 Apr. 2011 in Italy and which application is incorporated herein by reference. To the extent appropriate, a claim of priority is made to each of the above disclosed applications.

### BACKGROUND OF THE INVENTION

The present invention relates to the manufacture of products with a closed-section sandwich structure, comprising a core of lightweight material surrounded by a shell or skin of composite material, typically carboresin. The invention is intended to be used, in particular but not exclusively, in the aircraft construction sector, for example for the manufacture of moving surfaces such as tail units or fuselage parts and panelling in general of varying shape and size. More generally, the invention is applicable to any sector (for example the motor vehicle industry) where there is a need to have rigid and light structural parts.

In the applications most widely used hitherto, the core is formed by one or more parts made of honeycomb material. The manufacturing method starts with lamination of a layer of curable, fiber-reinforced, thermosetting composite material in an uncured condition; this first layer, which is intended to form a part of the outer shell of the product, is laminated on a lower forming tool of a matched mold curing apparatus formed so as to impart a predefined form to the composite layer. Then a block, not yet shaped, of honeycomb material is glued on top of the laminated layer and the assembly is transferred into an autoclave so as to perform curing of the bottom layer of composite material. Once curing has been performed, the body comprising the honeycomb material and the cured layer is transferred to a 5-axis numerical control machining unit which machines the surface of the honeycomb material which is still exposed, providing it with a predefined form. The body is then repositioned on the lower forming tool and a second layer of fiber-reinforced thermosetting composite material is laminated in an uncured condition on the surface of the honeycomb block which has just been machined. An upper forming tool of the curing apparatus is closed on top of the second laminated layer and a second curing cycle is performed inside the autoclave. Depending on the complexity of the core form, further machining operations may be required, followed by corresponding transfer into an autoclave for further curing cycles.

### SUMMARY OF THE INVENTION

The object of the invention is to manufacture products of the type discussed above in a simple, rapid and low-cost manner, using equipment which is less costly than that conventionally used. In particular the aim is to provide products with a very precise shape and size, but without having to make use of large-size numerical control machines which are disadvantageous from a cost point of view. The aim is also to simplify the handling and transfer operations within the production plant.

### BRIEF DESCRIPTION OF THE DRAWINGS

A preferred, but non-limiting embodiment of the method according to the invention will now be described with reference to the accompanying drawings in which:

FIG. 1 is a schematic horizontally sectioned view of a matched mold curing apparatus in the closed condition for molding in an autoclave the composite shell of a product having a core made of lightweight material;

FIG. 2 is a schematic cross-sectional view, on a larger scale, along the line II-II of FIG. 1; and

FIG. 3 is a schematic perspective view of a step for cutting a block of lightweight material in order to obtain one of the segments forming the core of the product according to FIGS. 1 and 2.

### DETAILED DESCRIPTION OF THE PREFERRED EMBODIMENT

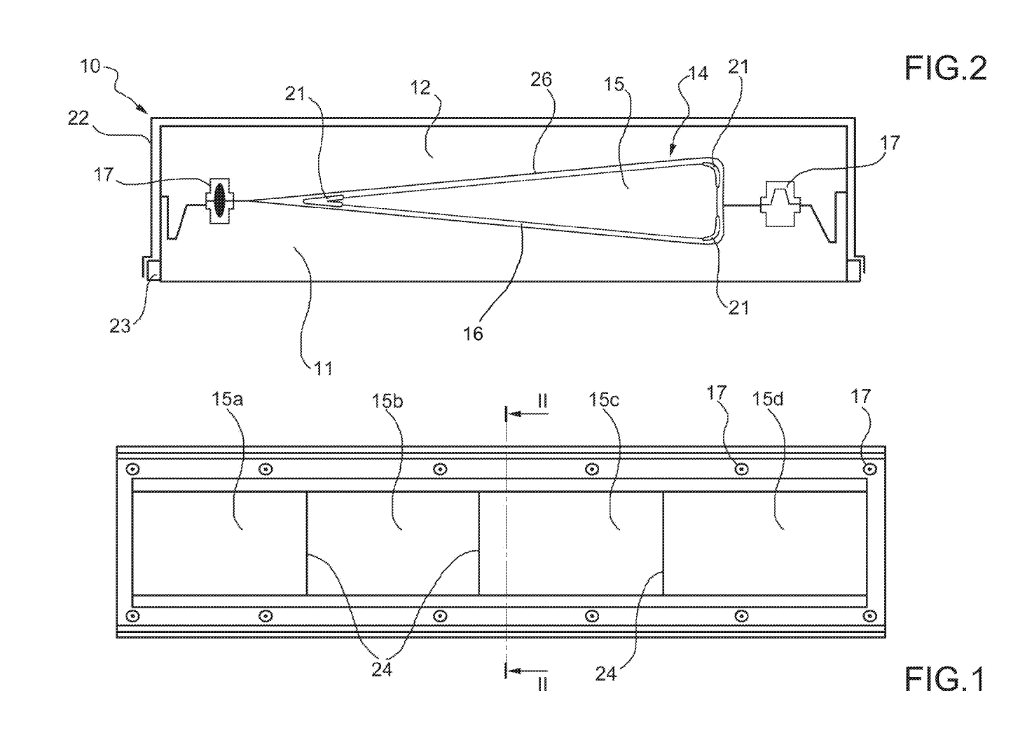

With reference initially to FIGS. 1 and 2, 10 denotes a curing apparatus, of the type known per se, comprising a lower mold 11 and an upper countermold 12 (the two molds being known per se as “matched mold”) which together define a molding cavity able to impart a given final external form to a product or a structural part 14 by means of simultaneous application of pressure and temperature, in particular, but not exclusively, inside an autoclave. The structural part 14, in this example a control surface of an aircraft, has a closed-section sandwich structure with a lightweight foam core 15 which is surrounded by a shell or skin 16 of carboresin or other curable, fiber-reinforced, thermosetting composite material, irrespective of whether it is of the long or short type.

In a first step of the method a series of superimposed layers or skins of fresh composite material 16 is laminated on the lower tool 11, by depositing for example in succession unidirectional fabrics or fibers (typically carbon fibers) preimpregnated with uncured thermosetting resin, in accordance with known methods which do not have to be described in detail here.

In order to produce the core 15, a plurality of consecutive core segments 15a-15d are provided and placed adjacent to one another in a direction “x” which is defined here as being longitudinal, on top of the fresh bottom layer 16. In the whole of the present description and in the claims the terms and expressions indicating positions and directions, such as “longitudinal” and “transverse” are to be understood as referring to the direction “x”. Expressions such as “internal”, “external”, “upper” or “lower” instead relate to the molding apparatus.

In other words, the core 15 is divided up into and formed by the set of core segments 15a-15d which have in this example the form of prism blocks aligned in the direction “x”. The desired form is imparted to the core segments by cutting the blocks (in this case parallelepipeds) of closed-cell foam. By way of example the following materials may be regarded as suitable for this purpose: Klegecell® TR or Divinycell® HT made by the company DIAB or alternatively Rohacell Type A or WF.

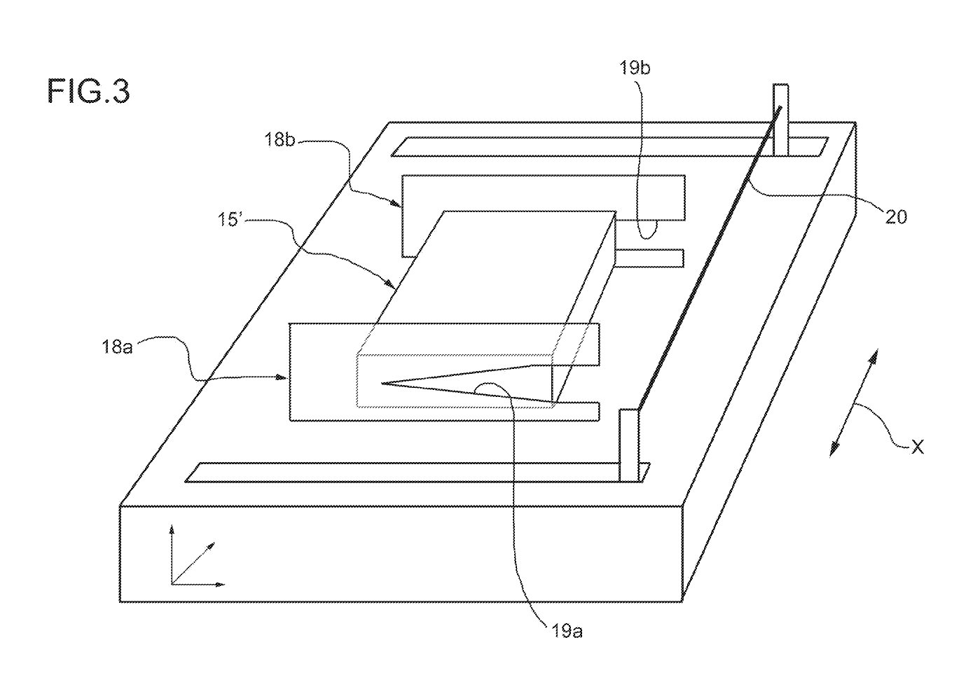

One of these blocks of foam, in this example having a parallelepiped shape, is denoted by 15′ in FIG. 3. In order to perform cutting of the block it is convenient to use a tool with a diamond-coated, thin, round, taut wire 20. Alternatively, depending on the type of pre-selected foam, it may be preferable to use a hot-wire cutting tool.

The blocks 15′ are obtained from an initial block (not shown) which is thus divided up initially into several blocks 15′ each having a predefined maximum dimension depending on the product to be made; advantageously dimensions are chosen such as to ensure the divided configuration defined during the design stage and facilitate handling and manual transportation of the individual blocks. Each block 15′ (FIG. 3) is held between a pair of lateral templates 18a, 18b which each reproduce the profile or shape 19a, 19b of the two respective ends of the core segments.

The templates also act as control guides for tracing cutting of the blocks so as to provide them with a shape corresponding to that of a portion of the molding cavity, situated between the lower tool and the upper tool. The diamond-coated wire which performs the cut vibrates alternately in a direction perpendicular to the templates and therefore in a direction substantially parallel to the longitudinal direction “x” of the core.

The profiles 19a, 19b of the templates 18a, 18b have dimensions which are slightly greater in relation to the predefined nominal dimensions, i.e. the free space inside the molding cavity defined between the parts 11 and 12 of the matched mold apparatus 10. In other words, the templates 18a, 18b define contours (or shapes or profiles) 19a, 19b having forms corresponding to cross-sections of the molding cavity, but dimensions slightly greater than the so-called “net trim” and molding cavity, as indicated hereinbelow.

The extent of the greater dimensions or oversizing of the core segments with respect to the mold depends on a series of factors, first and foremost the type of foam, its density and its softening point. This latter expression is understood as referring to the “moldability” temperature, i.e. the nominal temperature at which each type of foam may be plastically deformed. It is also necessary to take into account the size of the mold considered in the opening and closing direction, the temperature and the curing pressure of the autoclave. The margin or excess layer of the core segments may be equally well provided on the upper side or on the lower side of the segments or on both sides. Preliminary studies carried out by the Applicant have shown that excellent results, in terms of precision of the finished product, may be obtained if the core segments are oversized, when considered in planes transverse or perpendicular to the direction “x”, by about 0.2-1.5 mm with respect to the so-called “net trim”. This latter expression indicates the nominal size determined by the molding cavity in the closed condition, minus the thickness of the layers of composite material surrounding the core. The invention is not limited to the above-mentioned specific and optimum range.

The core segments 15a-15d are then coated with a layer 21 of expansion adhesive on the corner edges (using methods known per se), on the thinner zones and on the surfaces which face adjacent segments. The expansion adhesive has the function of ensuring that in all the zones of the molding cavity the pressure of the material is substantially uniform and in any case adequate and also making sure that any gaps or voids (for example owing to breakages in the thinner peripheral zones of the core) are filled with material, so as to obtain the final form of the product in accordance with the design requirements. Also the cavities between two consecutive segments are filled with expansion adhesive which, once hardening has taken place, will give rise to longitudinally spaced transverse partitions 24. For example, the products SynSpand 9899 and SynSpand 9890 commercially distributed by the company Henkel may be used as expansion resins.

According to a preferred embodiment, the core segments are deposited on the lower tool, bringing it into contact with a part of the segments which has not been oversized or oversizing of which is minimal compared to the other sides. In this way the segments are able to rest better inside the mold on a side where any imperfect fit between the surfaces of two adjacent segments is minimal.

At the same time as or after lamination of the composite material 16 on the lower tool, a series of superimposed layers or skins of composite material 26 comprising curable fiber-reinforced thermosetting resin in an uncured condition is also laminated on the upper tool 12 using the same methods adopted for the bottom layers.

Therefore, after positioning in the lower mold or tool 11 the core segments suitably coated with expansion adhesive, the upper mold 12 with the upper laminated layers 26 is placed on top of the core segments. The different parts of the matched mold apparatus are joined together precisely by means of tapered centring pins 17. Owing to the above-mentioned oversizing, the mold cannot be fully closed and fitted together at this stage.

A vacuum bag 22 with a peripheral sealing tape 23 is then applied in a manner conventional per se and the mold is placed inside an autoclave for curing. Advantageously, a single curing cycle is performed so as to produce curing of the entire shell of composite material and therefore both of the top part and of the bottom part. The use of an autoclave is not indispensable for the application of the temperatures and pressures necessary for curing; the method may be equally well implemented using heatable molds placed underneath a press.

The curing cycle must go through a series of predefined steps depending on the type of foam. Initially a heating step without the application of pressure is performed. The heating step envisages suitable heat gradient ramps (e.g. 5° C./min) up to a temperature close to a temperature value not less than 75% and not greater than 100% of the so-called softening point (or “moldability” temperature) which depends on the type of foam. In general the ramp must be sufficiently slow so as not to damage the foam or cause premature curing of the resin.

When the abovementioned softening (or moldable) condition of the core is reached, a step follows where the temperature is kept constant, with the controlled application of pressure regulated by the autoclave with a ramp for example of 1 bar/every 5 minutes until a predetermined constant pressure, for example of 2-10 bar, is reached on the basis of the mechanical properties of the foam forming the core. The pressure applied gradually during this step causes a plastic deformation of the foam, with a consequent increase in density of the core segments, in particular in the zones where the segments have larger dimensions.

The same pressure exerted by the autoclave, or by the press acting on the curing apparatus, causes closing of the mold.

This is followed by a pause at a substantially constant temperature and pressure so as to allow curing of the resin. Finally, cooling may be performed with a preferably slow ramp (for example for 1° C./min) until two-thirds of the softening point of the foam is reached. The choice of the resin and the adhesives to be used must be related to the type of foam so that the resin has a degree of viscosity which allows it to be worked when the foam softening temperature is reached. In other words, the gel time of the resin must be greater than the time which the foam requires in order to reach its softening point, or at least close to 70-80% thereof, so that the resin is not prematurely cured. Different types of foam and resin require in each case a different and appropriate application of the pressure and temperature values.

As can be appreciated, the method allows the manufacture of products with a high degree of dimensional precision without using costly numerical-control apparatus, but making use of the moldable nature of the material forming the core in order to obtain the desired geometrical form precisely determined by the mold and countermold of the curing apparatus.

With respect to the prior art which uses numerical-control machines for manufacture of the core, with the present invention it is possible to achieve a considerable reduction in the amount of time required since it is no longer required to perform long and costly dimensional checks at the end of manufacture of the core.

If an autoclave is to be used, the method requires a single autoclave step, thereby minimizing the transfer operations within the industrial plant.

The division of the core into segments with a manageable size facilitates the work for operators and dispenses with the need for special equipment in order to move conventional bulky single-piece cores within the plant. For example, an aircraft tail unit with a length of at least 5 metres may be prepared by assembling core segments, each with a length of about 0.5 metre. Trial tests carried out show that with the invention it is possible to reduce the amount of time required by about 40% compared to a conventional process of the type mentioned in the introduction.

The increase in density which is obtained in the core zones which are initially oversized results in an increase in the mechanical properties of the core which advantageously will be more rigid in the peripheral zones immediately adjacent to the shell of composite material. These zones, at the interface with the outer layers of composite material, are in fact the parts of the core which are most exposed to shearing forces. Their reinforcement therefore increases the overall structural strength of the product.

A further advantage provided by the present invention consists in the fact that a particularly high precision is not required to perform the cutting of blocks in order to obtain the core segments. More particularly, it is not indispensable for the increased dimensions or oversizing of the core segments to be constant or uniform in the whole of their peripheral zone. Owing to the fact that the core segments must be formed (and therefore cut) oversized, any core segments cut in such a way that they exceed locally the predefined oversizing may also be used without the need for further machining, since the foam in excess of the nominal dimensions is eliminated by making use of the capacity of the foam to be plastically deformed under the action of the pressure and temperature applied. Cutting of the core segments may be advantageously performed in a relatively approximate manner, rapidly and with the aid of apparatus which are considerably less costly than those used hitherto, as discussed in the introductory part of the present description.

In order to prevent the core segments from being cut with superficial zones having dimensions smaller than the nominal dimensions, it is sufficient to choose a cutting machine with a tolerance less than the oversizing which is predetermined depending on the type of foam.

It is understood that the invention is not limited to the particular embodiment described and illustrated here, which is to be regarded as an example of production. The invention may be subject to modification in terms of forms, dimensions, arrangement of parts, materials used and methods of application of the temperature and pressure in an autoclave, so as to manufacture virtually any product with a closed-section sandwich structure having a core of lightweight material surrounded by a shell of composite material. For example, splitting of the core, i.e. its subdivision into a greater (or smaller) number of segments which are smaller (or larger) in length, may vary depending on the form and dimensions of the core, its complexity, its variation along the direction “x”, and the degree of dimensional precision to be achieved. Various pairs of templates with corresponding shapes may be provided in order to cut core segments in accordance with particular design requirements. Finally, depending on the form and dimensions of the product, the core segments may be arranged adjacent to one another in more than one predetermined direction, for example in the form of two or more groups of parallel straight lines, for example in a grid arrangement.

What is claimed is:

1. A method for manufacturing a product with a closed-section sandwich structure, comprising a core of lightweight material surrounded by a shell of composite material, the method comprising the following steps:
providing a matched mold curing apparatus defining a molding cavity and comprising at least a lower forming tool and at least an upper forming tool;
laminating on the lower forming tool a first set of superimposed layers of curable, fiber-reinforced, thermosetting composite material in an uncured condition;
laminating on the upper forming tool a second set of superimposed layers of curable, fiber-reinforced, thermosetting composite material in an uncured condition;
providing a plurality of core segments made from blocks of closed-cell foam suitable for forming together the core of the product;
laying the core segments adjacent to one another on said first set of layers in at least a predetermined direction, wherein the core segments are oversized relative to a plane transverse to said predetermined direction, by a predetermined thickness with respect to a nominal size determined by the molding cavity in a closed condition, minus a thickness of the first and second sets of composite layers;
laying the upper forming tool with the second set of layers over the core segments without closing completely the matched mold;
initially applying a controlled temperature to plastically deform the core segments;
then applying temperature and pressure to cause a complete closure of the matched mold and curing of a thermosetting resin matrix of the laminated layers.

2. A method according to claim 1, wherein the initial step of applying temperature includes a controlled heating step without applying pressure on the curing apparatus, until the temperature reaches a predetermined temperature not below 75% and not exceeding 100% of a softening point of the closed-cell foam of the core segments.

3. A method according to claim 1, wherein said subsequent step of applying temperature and pressure includes the steps of:
gradually applying pressure on the curing apparatus until the pressure reaches a predetermined pressure level, resulting in complete closure of the matched mold, and
upon reaching the predetermined pressure level, keeping the pressure substantially constant.

4. A method according to claim 3, wherein the temperature is kept substantially constant during said steps wherein the pressure is gradually applied and then kept at the predetermined pressure level.

5. A method according to claim 1, wherein the step of curing the thermosetting resin matrix of the laminated layers includes applying constant pressure and temperature and wherein said curing step is followed by a final controlled cooling step until a temperature corresponding to about two-thirds of the softening point of the foam of the core is reached.

6. A method according to claim 1, wherein the thermosetting resin matrix of the laminated layers is chosen to have a gel time not less than 70% of the time required for the foam to reach the softening point, so as to prevent premature curing of the resin matrix.

7. A method according to claim 1, wherein the core segments are given a desired shape by cutting closed-cell foam blocks.

8. A method according to claim 7, wherein each block of foam is held between a pair of lateral templates which each reproduce a profile of one of two respective ends of a core segment.

9. A method according to claim 8, wherein the blocks are cut by a wire tensioned in a direction perpendicular to the templates and in a direction substantially parallel to said predetermined direction.

10. A method according to claim 7, wherein the cut is performed by a cutting machine having a tolerance less than the oversizing which is predetermined depending on a type of closed-cell foam of the core segments.

11. A method according to claim 1, wherein the core segments are laid on the lower forming tool, bringing the lower forming tool into contact with a part of the segments which has not been oversized or which has minimal oversizing compared to other sides of the core segments.

12. A method according to claim 1, wherein oversizing of the core segments with respect to said nominal size is between about 0.2 mm and about 1.5 mm.
